(19) United States
(12) Patent Application Publication
(10) Pub. No.: US 2012/0293651 A1
(43) Pub. Date: Nov. 22, 2012

(54) DISTANCE MEASUREMENT DEVICE AND DISTANCE MEASUREMENT METHOD

(75) Inventors: Shinya Kawamata, Gotemba-shi (JP); Ryuji Funayama, Yokohama-shi (JP); Shin Satori, Sapporo-shi (JP); Yoshihide Aoyanagi, Sapporo-shi (JP); Tadayoshi Komatsuda, Sapporo-shi (JP)

(73) Assignee: TOYOTA JIDOSHA KABUSHIKI KAISHA, Toyota-shi (JP)

(21) Appl. No.: 13/574,460

(22) PCT Filed: Jul. 23, 2010
(86) PCT No.: PCT/JP10/62403

§ 371 Date: Jul. 20, 2012

(51) Int. Cl. H04N 7/18

(52) U.S. Cl. 348/135; 348/E07.085

(57) ABSTRACT

A distance measurement device measures target distances to a measurement target by optically detecting the measurement target using a lens. The image formation relative quantity calculating part of the distance measurement device creates an image of the measurement target by causing light having a plurality of wavelengths from the measurement target to form an image by part of the lens. By further determining the image formation distances from the lens to the image for each wavelength, image formation relative quantities, which are quantities indicating the relative relationship between the image formation distances, are calculated. A recording part records correlation information, which is information defined by the chromatic aberration characteristics of the lens, in a manner so as to indicate the correlation between image formation relative quantities and target distances. A distance calculating part calculates the target distances by matching the image formation relative quantities to the correlation information.

### TECHNICAL FIELD

The present invention relates to a distance measurement device that measures the distance between the device itself and a measurement target by optically detecting the measurement target presence in the surrounding environment, particularly in a traffic environment, and to a method for measuring the distance suitable for use in the distance measurement device.

### BACKGROUND ART

Conventionally, a distance measurement device that measures the distance between the device itself and a measurement target by optically detecting light selected from visible light and non-visible light has been put to practical use as a device for measuring the distance between the device itself and the measurement target. Such a distance measurement device is mounted on a vehicle, which is a movable body, for example, to thereby measure the distance (relative distance) to another vehicle, which is a measurement target, and the vehicle carrying the device, that is, the distance measurement device itself. The distance measurement device provides information regarding the distance thus measured to a drive support device or the like as a piece of drive support information for supporting avoidance of collision or the like with other vehicle.

There is known a distance measurement device, for example, disclosed in Patent Document 1 and Patent Document 2 as a device that optically measures the distance to a measurement target as described above.

The distance measurement device described in Patent Document 1 has a light source by which light of a predetermined pattern having mutually different wavelengths are projected on a measurement target, so that images of a light pattern projected on the measurement target is picked up from a different direction from an optical axis of the light source. Then, the distance measurement device of Patent Document 1 measures the distance to the measurement target based on a variation of the picked up light patterns with respect to the projected light pattern. Thus, according to the distance measurement device of Patent Document 1, light having an intensity high enough to be picked up needs to be projected on the measurement target from the light source. Therefore, when such a distance measurement device is mounted on a vehicle, light patterns having an intensity high enough to be picked up needs to be projected on the measurement target, which is sometimes located several tens of meters to several hundreds of meters away from the light source. Accordingly, energy consumed by the light source is so high that it cannot be ignored.

Patent Document 2 discloses an example of a distance measurement device using no light source. The distance measurement device of Patent Document 2 has two cameras with a predetermined interval therebetween, one of which is a camera responsive to a visible spectral range, and the other one is a camera responding to an infrared spectral range. The distance measurement device is configured to measure the distance to the measurement target by applying a triangulation method to images of the same measurement target picked up by the two cameras.

### PRIOR ART DOCUMENT

### Patent Document

Patent Document 1: Japanese Laid-Open Patent Publication No. 2002-27501
Patent Document 2: Japanese National Phase Laid-Open Patent Publication No. 2007-506074

### SUMMARY OF THE INVENTION

### Problems that the Invention is to Solve

Although the distance measurement device of Patent Document 2 mentioned above consumes less energy because the device does not require a special light source, the clearance between the two cameras, which are references of the triangulation method, needs to be accurately maintained to obtain high measurement precision. However, since the distance measurement device mounted on the vehicle is affected by vibration, distortion, and the like of a vehicle body, it is difficult to accurately maintain the clearance between the two cameras installed on the vehicle body. Thus, when the distance measurement device is mounted on a vehicle in particular, there is still a room for improvement from a practical standpoint from an aspect of simplification of the structure.

Accordingly, it is an objective of the present invention to provide a distance measurement device capable of measuring the distance between the device itself and a measurement target with a simple structure even in a case of being mounted on a vehicle and the like, and a method for measuring the distance suitable for use with the distance measurement device.

### Means for Solving the Problems

Means for solving the above objectives and advantages thereof will now be discussed.

To achieve the foregoing objective, the present invention provides a distance measurement device for measuring target distance, which is distance to a measurement target, by optically detecting the measurement target using a lens. The device includes image formation relative quantity calculating means, storing means, and distance calculating means. The image formation relative quantity calculating means creates an image of the measurement target by causing light having a plurality of wavelengths emitted from the measurement target to form an image via a lens, and determines the imaging distances from the lens to the image for each wavelength, thereby calculating an image formation relative quantity as a quantity indicating a relative relationship between the image formation distances. The storing means stores correlation information as information that is determined by chromatic aberration characteristics of the lens so as to indicate a correlation between the image formation relative quantity and the target distance. The distance calculating means calculates the target distance by comparing the image formation relative quantity with the correlation information.

Usually, a lens has mutually different refractive indexes for each of incident lights having mutually different wavelengths. That is, chromatic aberration is generated in a normal lens, and therefore when the incident light has a plurality of wavelengths, the image formation distance from the lens to the image is different in each wavelength in a case of imaging the incident light by the lens. Further, the image formation distance of an image of a light having a single wavelength is also varied depending on a difference of an incident angle of the light incident on the lens, the difference being caused by variation of the distance between the lens and the measurement target. In general, chromatic aberration of lenses is corrected. Specifically, lenses are generally designed to match the image formation distances of lights having different wavelengths desired to be obtained, for example, the wavelength of red light, the wavelength of green light, and the wavelength of blue light, for images.

According to this configuration, the distance to a measurement target is calculated (measured) by comparing the image formation relative quantities calculated by detecting a measurement target with the information indicating a correlation between image formation relative quantities of the image formation distance between the lights each having a wavelength, and the distance to the measurement target, which is information determined by the distance to the measurement target and the characteristics of the lens. Thus, the distance to the measurement target can be measured irrespective of using a lens (optical system) of which difference between image formation distances (or chromatic aberrations) as a difference between the image formation distances corresponding to mutually different wavelengths is not corrected, or irrespective of using light having a wavelength in which the difference between image formation distances (chromatic aberrations) of the lens is not corrected. That is, in the distance measurement device with this configuration, there is no necessity for correcting the difference between image formation distances (chromatic aberrations) for each wavelength. Therefore, the structure of the optical system such as a lens can be simplified.

Further, according to this configuration, the difference between image formation distances (chromatic aberrations) is obtained for each wavelength, by detecting each wavelength image formation distance using a common lens (optical system). Therefore, the distance can be measured by one optical system, namely by one camera. Thus, in comparison with a case in which a plurality of cameras are used, the degree of freedom of arranging the camera, etc. can be increased, and there is no necessity for maintaining an arrangement position of each camera with high precision. Accordingly, the structure of the distance measurement device can be simplified.

Further, according to this configuration, the distance can be measured using the light having a wavelength of which the difference between image distances is not corrected. Therefore, the degree of freedom is increased in selecting and designing the wavelength used for the distance measurement device, and the degree of freedom is also increased in selecting and designing the optical system that is used in this distance measurement device.

It may be configured such that the light has two wavelengths having different image formation distances, and the correlation information forms map data in which the image formation relative quantity is associated with the target distance.

According to this configuration, the distance to the measurement target of the image is measured based on light having two wavelengths and which have different image formation distances from the lens from each other. Thus, the distance to the measurement target can be measured even from light of two wavelengths. Therefore, the distance can easily be measured.

The image formation relative quantity may be a difference between image formation distances, which is the difference between the imaging distances of the two wavelengths.

According to this configuration, the image formation relative quantities, namely the chromatic aberrations, are detected as the difference between the image formation distances of the light having two-wavelengths. Therefore, arithmetic operation is easy, which is required for detecting the image formation relative quantities.

The image formation relative quantity may be an image formation distance ratio, which is the ratio between the image formation distances of the two wavelengths.

According to this configuration, the image formation relative quantities are detected as the ratio between the image formation distances of light having two wavelengths. Therefore, the arithmetic operation required for detection is easy.

In order to determine the image formation distance, the image formation relative quantity calculating means may be configured such that the distance between the lens and an image formation plane for picking up the image is variable.

According to this configuration, the image formation distance can be obtained directly from the distance between the lens and the image formation plane. Therefore, the detection of the image formation distance is easy.

The image formation relative quantity calculating means may be configured to move the image formation plane with respect to the lens.

According to this configuration, constituent elements constituting the image formation plane are moved, in a case where the image formation plane is smaller than the optical system in many cases. Therefore, miniaturization and simplification of the distance measurement device is achieved. For example, the image formation plane constituted of picture elements such as CCD is smaller and lighter than the optical system. Therefore, the structure for moving such an image formation plane can also be simplified.

The image formation plane may be configured to swing about a swing shaft, and the image formation relative quantity calculating means may vary the distance between the lens and the image formation plane by controlling the swing of the image formation plane.

According to this configuration, the image formation plane can be moved away from or closer to a surface of the lens by swinging a swing shaft. Thus, the structure for moving the image formation plane with respect to the lens can be simplified.

The distance measurement device may further include a second lens positioned between the first lens and the measurement target, and the image formation relative quantity calculating means may determine the image formation distance based on the distance between the first lens and the second lens. That is, the image formation relative quantity calculating means may determine the image formation distance from the relative distance between the two lenses when an image of light from the measurement target is formed on an image formation plane.

According to this configuration, the difference between image formation distance of the light having two wavelengths can be calculated based on the image formation distance of the lens which varies corresponding to the variation of the relative distance between the two lenses.

The first lens may be a part of a spectral sensor for detecting light from the measurement target.

That is, an image of light detected by the spectral sensor for detecting the light from the measurement target may be the image of the measurement target formed by the lens.

According to this configuration, light having a plurality of given wavelengths can be detected by using the spectral sensor. Therefore, based on the image formation distance of the image of the light having such a detected wavelength, a plurality of image formation relative quantities can be calculated. Precision of the measured distance can be increased by measuring the distance based on the plurality of image formation relative quantities. Further, since the spectral sensor's degree of freedom in selection is high, it becomes easy for the spectral sensor to suitably select the light having a wavelength suitable for measuring the distance, in accordance with a surrounding environment and ambient light. Further, since the spectral sensor can detect light having multiple wavelengths, the distance measurement device can easily be constituted. That is, the distance measurement device can be constituted by utilizing an existing spectral sensor.

Also, in order achieve the foregoing objective, the present invention provides a method for measuring target distance, which is distance to a measurement target, by optically detecting the measurement target using a lens. The method includes: an image formation distance detecting step for creating an image of the measurement target by causing light having a plurality of wavelengths emitted from the measurement target to form an image via the lens, and detecting image formation distances from the lens to the image for each of the wavelengths; a relative relationship quantity calculating step for calculating an imaging relative quantity, which is a quantity indicating a relative relationship between the image formation distances; and a distance calculating step for calculating the target distance by matching the image formation relative quantity with correlation information, which is information determined by chromatic aberration characteristics of the lens to indicate a correlation between the image formation relative quantity and the target distance.

The normal lens has mutually different refractive indexes for each of incident lights having different wavelengths. That is, chromatic aberrations are generated in the normal lens, and therefore in a case where the incident light has multiple wavelengths, the image formation distance from the lens to the image is different for each wavelength when an incident light is imaged by the lens. The image formation distance of the single wavelength light is also varied by such a difference of an incident angle of the light incident on the lens, which is caused by the variation of the distance between the lens and the measurement target. In general, chromatic aberrations of lenses are corrected. Specifically, lens are generally designed to match the image formation distances of lights having different wavelengths desired to be obtained, for example, the wavelength of red light, the wavelength of green light, and the wavelength of blue light, for images.

According to the aforementioned method for measuring the distance, correlation information indicating the correlation between the target distance and the image formation relative quantities between the image formation distances of the image for each wavelength is determined by the target distance and the characteristics of the lens. The target distance is calculated or measured by comparing the image formation relative quantities calculated by detecting the measurement target with the correlation information. Thus, the target distance is measured even if the chromatic aberrations of the lens or the optical system is not corrected, namely, even if the difference between image formation distances as the difference between image formation distances of the lights having different wavelengths is not corrected. That is, according to the aforementioned method for measuring the distance, the target distance can be measured even in a case of using the light from the lens of which difference between image formation distances or the chromatic aberrations is not corrected. That is, according to the aforementioned method for measuring the distance, there is no necessity for correcting the image formation distances or the chromatic aberrations for each wavelength. Therefore, the aforementioned method for measuring the distance can be realized even in a case of an optical system having a lens of a simple structure.

Further, according to the aforementioned method for measuring the distance, the difference between image formation distances or the chromatic aberrations for each wavelength is obtained based on the image formation distance of the single wavelength light detected by the common lens or the common optical system. Therefore, the distance can be measured based on the image detected by one optical system or one camera. According to the aforementioned method for measuring the distance, the degree of freedom for arranging the camera and the like can be increased, compared with a method requiring a plurality of cameras, for example.

According to the aforementioned method for measuring the distance, the distance is measured using light of which image formation distance is not corrected. That is, according to the method for measuring the distance, the degree of freedom is high in selecting and designing the wavelength to use. Also, the degree of freedom is high in selecting and designing the optical system in a device for executing the method for measuring the distance.

In the image formation distance detecting step, the image formation distance may be detected for each of the two wavelengths. In the distance calculating step, the correlation information may be obtained from map data, in which the image formation relative quantity is associated with the target distance.

According to this method, the distance to the measurement target is measured, based on light having two wavelengths. Therefore, the distance can be easily measured.

In the image formation distance detecting step, the image formation distances may be detected for each wavelength based on a definition of the image.

Definition of the image is assessed based on the degree of variation of light quantities between a pixel of the image itself and a pixel around the image, for example. A method for measuring the definition of the image itself can be executed by a known method, thus making it easy to suitably execute the aforementioned method for measuring the distance.

### BRIEF DESCRIPTION OF THE DRAWINGS

FIG. 1 is a block diagram showing a system configuration of a spectrum measurement device according to a first embodiment, which is a distance measurement device of the present invention, together with a movable body on which the spectrum measurement device is mounted;

FIG. 2 is a schematic diagram showing the structure of an optical system used for the spectrum measurement device of FIG. 1;

FIG. 3 is a schematic diagram showing an image formation distance for forming an image of a measurement target by the optical system of FIG. 2, wherein FIG. 3(a) shows an image formation distance in a case in which the measurement target is located far away, FIG. 3(b) shows the image formation distance in a case in which the measurement target is closer to the spectrum measurement device than the case of FIG. 3(a), and FIG. 3(c) shows the image formation distance in a case in which the measurement target is closer to the spectrum measurement device than the case of FIG. 3(b);

FIGS. 4(a) to 4(d) are schematic diagrams showing a case in which the same measurement target is projected on an image formation plane of the optical system of FIG. 2, as an image of light having different wavelengths;

FIG. 5 shows a graph showing a relationship between a difference between image formation distances of light having two wavelengths and a distance from the spectrum measurement to the measurement target detected by the spectrum measurement device of FIG. 1;

FIG. 6 is a flowchart showing a procedure of measuring the distance by the spectrum measurement device of FIG. 1;

FIG. 7 is a schematic diagram showing the structure of a spectrum measurement device, which a distance measurement device according to a second embodiment of the present invention;

FIG. 8 is a schematic diagram showing a case in which the image formation distance is measured by the optical system of the spectrum measurement device of FIG. 7;

FIGS. 9(a) and 9(b) are schematic diagrams showing a case in which the image formation distance is measured by the optical system of the spectrum measurement device of FIG. 7; and

FIG. 10 is a view showing the structure of a spectrum measurement device according to a modified embodiment, which is a distance measurement device of the present invention.

### BEST MODE FOR CARRYING OUT THE INVENTION

### First Embodiment

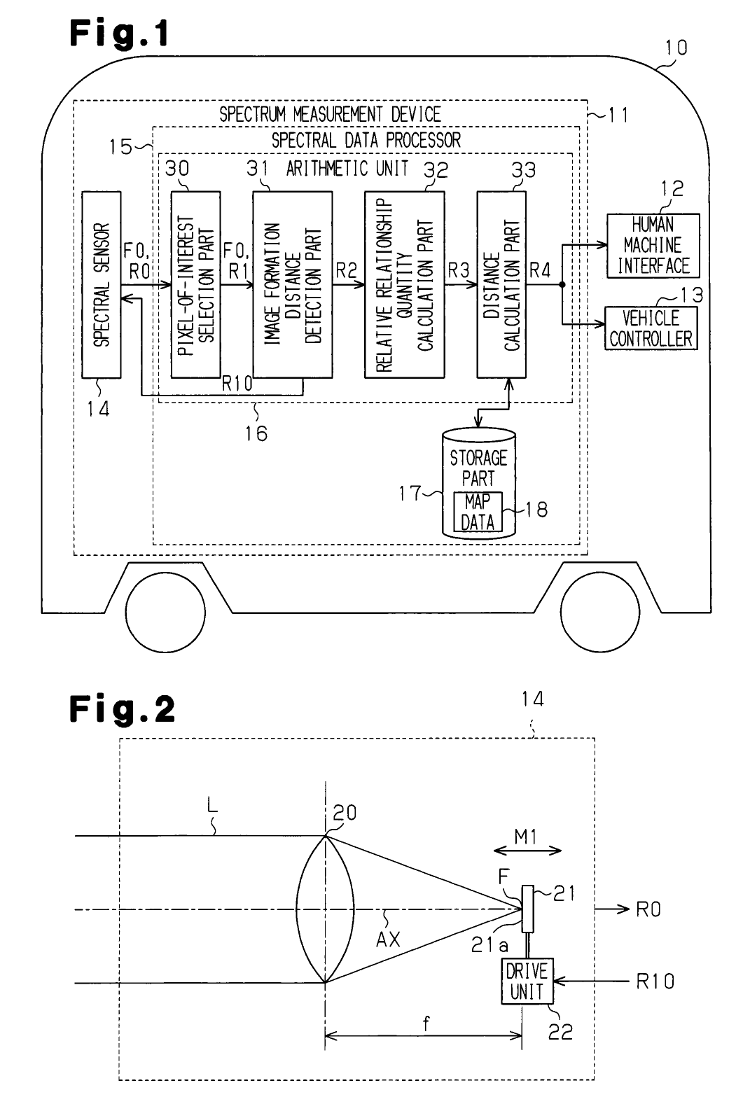

FIGS. 1 to 6 illustrate a spectrum measurement device 11 according to a first embodiment, which a distance measurement device of the present invention. As shown in FIG. 1, the spectrum measurement device 11 is mounted on a vehicle 10, which is a movable body. That is, FIG. 1 is a block diagram schematically showing the system configuration for the spectrum measurement device 11, which is the distance measurement device mounted on the vehicle 10, which is a movable body.

In recent years, a technique has been considered for practical application that identifies a measurement target present in the surrounding environment of a spectral sensor, from multispectral data including an invisible optical region measured by the spectral sensor, and provides various kinds of support information to a driver in accordance with the identified measurement target or a state of the measurement target. For example, a drive support device that has been examined for practical application in a vehicle, such as an automobile, identifies pedestrians or other vehicles that exist in the surrounding traffic environment of the vehicle, based on the spectral data measured by the spectral sensor mounted on the vehicle, to thereby support driving or decision-making of the driver.

Further, in order to support a driver, who operates a movable body such as a vehicle, or to avoid or prevent, for example, the movable body from colliding with other object, information indicating a relative position of the measurement target with respect to the movable body is essential. Therefore, conventionally, some vehicles are provided with a distance measurement device that measures a relative position of a measurement target with respect to the vehicle itself, and the aforementioned devices described in Patent Document 1 and Patent Document 2 are known as such a distance measurement device. However, when the spectrum measurement device and the distance measurement device are provided to the vehicle individually, inconveniences are generated, such as an increased area occupied by these devices, a complicated structure of the whole body of the vehicle, or an increased cost. Therefore, simplification of the system configuration of these sensors is desired. This embodiment enables the spectrum measurement device to be used as the distance measurement device capable of measuring a distance between the distance measurement device itself and the measurement target with a simple structure, even when the spectrum measurement device is mounted on the vehicle, and the like.

The spectrum measurement device 11 shown in FIG. 1 is configured to identify the measurement target by obtaining optical information including visible light and invisible light outside the vehicle, and to measure the distance between the spectrum measurement device 11 itself and the measurement target. Further, the vehicle 10 includes a human machine interface 12 for transmitting identification information and distance information output from the spectrum measurement device 11 to an occupant of the vehicle 10, and a vehicle controller 13 for reflecting the identification information, the distance information, and the like, output from the spectrum measurement device 11, in control of the vehicle. Since the spectrum measurement device 11 identifies the measurement target by a known method, the structure of a portion of the spectrum measurement device 11 for identifying the measurement target is omitted, and also redundant description of a identification processing portion or the like for identifying the measurement target is omitted in this embodiment for explanatory convenience.

The human machine interface 12 transmits a vehicle state or the like to the occupant, particularly to a driver, through light, color, sound, and the like. Further, the human machine interface 12 is a known interface device provided with an operation device such as a push button and a touch panel, so that the intention of the occupant can be input through buttons, and the like.

The vehicle controller 13 as one of various controllers mounted on the vehicle is directly or indirectly connected by on-vehicle network to various kinds of other controllers such as an engine controller, which is similarly mounted on the vehicle, so that required information can be transmitted to each other. According to this embodiment, when the information regarding the measurement target and the information regarding the distance to the measurement target identified by the spectrum measurement device 11 are input from the spectrum measurement device 11, the vehicle controller 13 transmits the information to various controllers. Further, the vehicle controller 13 is configured to execute a requested driving support in this vehicle 10, in accordance with the identified measurement target and the distance to the measurement target.

As shown in FIG. 1, the spectrum measurement device 11 includes a spectral sensor 14 for detecting spectral data R0 regarding observation light, which is a light obtained by observing the measurement target, and a spectral data processor 15 for receiving and processing the spectral data R0 from the spectral sensor 14.

The spectral sensor 14 is configured to generate the spectral data R0 regarding the observation light by detecting a spectrum image of the observation light. A plurality of pixels that constitute the spectrum image each include individual spectral data.

The spectral sensor 14 has a function of dispersing the observation light, which is the light composed of the visible light and the non-visible light, to predetermined wavelength bands. The spectral data R0 output from the spectral sensor 14 has wavelength information as the information indicating wavelengths that constitutes the wavelength band after dispersion, and optical intensity information as the information indicating optical intensity of the observation light for each wavelength of these wavelength bands. The spectral sensor 14 of this embodiment previously selects a first wavelength (λ1), i.e., a short wavelength of 400 nm (nanometer), and selects a second wavelength (λ2), i.e., a long wavelength of 800 nm which is longer than the short wavelength. That is, the spectral data R0 includes spectral data of the light having a wavelength of 400 nm, and the spectral data of the light having a wavelength of 800 nm.

As shown in FIG. 2, the spectral sensor 14 includes a lens 20 for imaging incident light L, a detector 21 for detecting the imaged light, and a drive unit 22 for driving the detector 21. Further, the spectral sensor 14 includes a filter (not shown) for generating the incident light L from the observation light. That is, the filter of this embodiment selects from the observation light an optical component out of various optical components that constitute the incident light L as a main wavelength.

The lens 20 is a convex lens, and therefore when the incident light L is incident on the lens 20, refracted and transmitted light is emitted from the lens 20. According to this embodiment, the incident light L is parallel to an optical axis AX of the lens 20, and therefore the transmitted light is imaged on an image formation point F positioned on the optical axis AX. Generally, a refractive index of the lens 20 is different for each wavelength of the incident light L. That is, the lens 20 has a chromatic aberration, and an image formation distance f from the lens 20 to the image formation point F is varied in accordance with the wavelength of the incident light L incident on the lens 20. Therefore, the incident light L incident on the lens 20 is imaged on the image formation point F, which is spaced away from the lens 20 by an image formation distance f corresponding to the wavelength of the incident light L, in accordance with the refractive index defined on the basis of the wavelength of the incident light L and the chromatic aberration characteristics of the lens 20. That is, the image formation distance f of the lens 20 is varied on the optical axis AX of the lens 20 in accordance with the wavelength of the incident light L. Specifically, as the wavelength of the incident light L becomes shorter, the image formation distance f of the lens 20 also becomes shorter.

The detector 21 is composed of light receiving elements such as a CCD. An image formation plane 21a as an imaging plane constituted by the light receiving surface of the light receiving elements is disposed to face the lens 20. On the image formation plane 21a, the detector 21 detects optical intensity information regarding the incident light L.

The drive unit 22 drives the detector 21 to move in a front-rear direction M1, namely in a direction along the optical axis AX of the lens 20. That is, the image formation plane 21a of the detector 21 is moved on the optical axis AX of the lens 20 by the drive unit 22 so as to be positioned at any image formation distance f. Therefore, the image formation plane 21a is moved in a direction approaching the lens 20, namely in the forward direction, or in a direction away from the lens 20, namely in the back direction. Therefore, the drive unit 22 allows the image formation plane 21a to be positioned corresponding to the image formation distance f that varies in accordance with the wavelength of the incident light L.

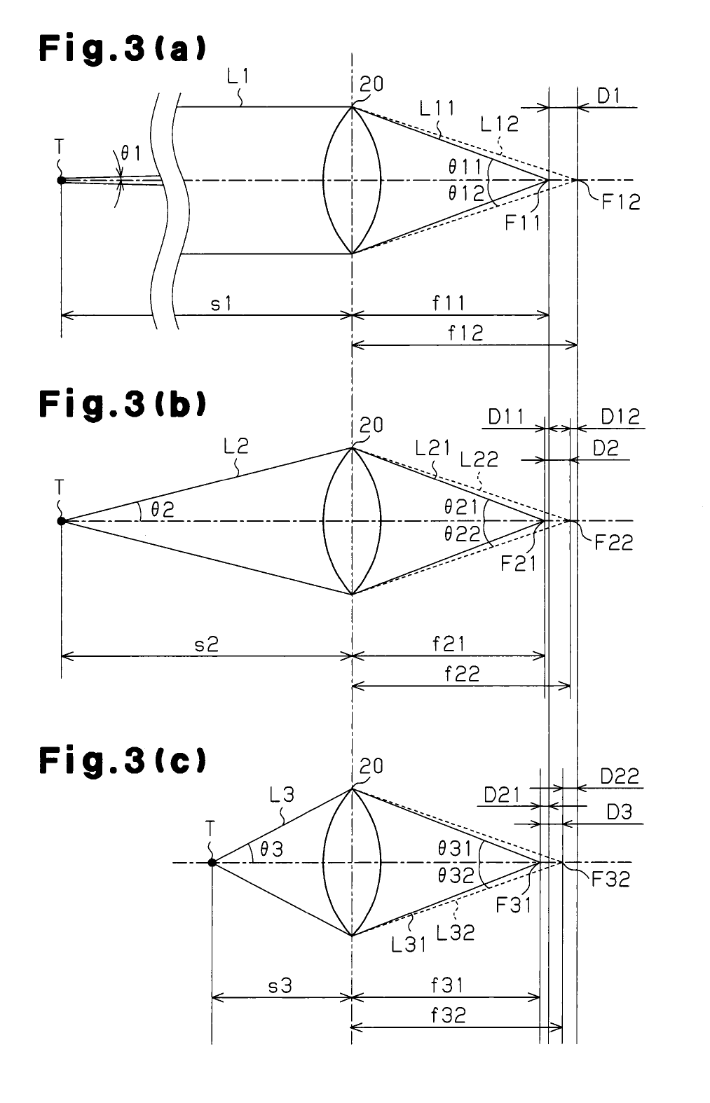

FIGS. 3(a) to 3(c) are schematic diagrams showing the relationship between the image formation distance f and an object distance s, which is the distance from the lens 20 to a measurement target T, respectively. FIG. 3(a) shows a case in which the measurement target T exists far from the lens 20, and FIG. 3(b) shows a case in which the measurement target T exists closer to the lens 20 than the case of FIG. 3(a). FIG. 3(c) shows a case in which the measurement target T exists closer to the lens 20 than the case of FIG. 3(b).

The measurement target T of FIG. 3(a) is positioned far from the lens 20 by a far target distance s1 that can be evaluated as an infinite distance. A far incident light L1, which is the incident light from the measurement target T in this case, is incident on the lens 20 as substantially parallel lights. When the far incident light L1 is a single wavelength light having a short wavelength only, such as the wavelength of 400 nm, the far incident light L1 is refracted by a refractive index of the lens 20 corresponding to the wavelength 400 nm, and a far/short transmitted light L11 as the transmitted light is emitted from the lens 20. The far/short transmitted light L11 is imaged on the far/short image formation point F11 which is away from the lens 20 by far/short image formation distance f11 as the image formation distance. FIG. 3(a) shows a far/short convergence angle θ11 as the convergence angle or a concentration angle showing a steep degree of convergence which allows a portion of the far/short transmitted light L11 emitted from a peripheral edge of the lens 20 to be converged on the far/short image formation point F11.

In contrast, when the far incident light L1 is a single wavelength light having, for example, a long wavelength of 800 nm, which is different from the short wavelength, the far incident light L1 is refracted by the refractive index of the lens 20 corresponding to the wavelength of 800 nm. A far/long transmitted light L12 in this case is converged by a far/long convergence angle θ12 and is imaged on a far/long image formation point F12, which is away from the lens 20 by far/long image formation distance f12. The measurement target T of FIG. 3(a) can be evaluated to exist infinitely far from the lens 20, and therefore the far/short image formation distance f11 shows a short wavelength focal distance of the lens 20, and the far/short image formation point F11 shows a short wavelength focal point of the lens 20. Similarly, the far/long image formation distance f12 shows a long wavelength focal length of the lens 20, and the far/long image formation point F12 shows a long wavelength focal point of the lens 20.

Generally, in a case of a lens of which chromatic aberrations are not corrected, there is a tendency that the refractive index of the lens becomes larger as the wavelength of the incident light L becomes shorter. That is, there is a tendency that the image formation distance f becomes shorter as the wavelength of the incident light L becomes shorter, because the convergence angle becomes large. This indicates that as shown in FIG. 3(a) the refractive index of the far/short transmitted light L11 having a short wavelength of 400 nm is larger than the refractive index of the far/long transmitted light L12 having a long wavelength of 800 nm. That is, the far/short convergence angle θ11 is larger than the far/long convergence angle θ12. Therefore, the far/short image formation distance f11 is shorter than the far/long image formation distance f12. Thus, a difference between the image formation distances, namely, difference D1 in far image formation distances (D1=far/long image formation distance f12−far/short image formation distance f11) is generated between the far/short transmitted light L11 and the far/long transmitted light L12, as a relative quantity or an image formation relative quantity of the image formation distances which is caused by the difference in wavelengths.

The measurement target T shown in FIG. 3(b) is positioned away from the lens 20 by a middle target distance s2, which is shorter than the far target distance s1. A middle expansion angle θ2 shown in FIG. 3(b) is an expansion angle or an inlet angle indicating an expansion degree of the middle incident light L2 as the incident light in this case, toward the peripheral edge of the lens 20 from the measurement target T. As the expansion angle becomes larger, the incident angle incident on the lens 20 is increased. A far expansion angle θ1, which is the expansion angle in a case of FIG. 3(a), is almost zero. When the middle/incident light L2 is a single wavelength light having a short wavelength of 400 nm, a refraction degree of the middle incident light L2 is determined based on the middle expansion angle θ2 and the refractive index of the lens 20 corresponding to the short wavelength. For example, in this case, a middle/short conversion angle θ21 is different from the far/short conversion angle θ11, and a middle/short image formation point F21 of the middle/short image formation distance f21 which allows the middle/short transmitted light L21 to be imaged is also different from the case of FIG. 3(a).

In contrast, when the middle incident light L2 is a single wavelength light having a long wavelength of 800 nm, the middle incident light L2 is refracted based on the middle expansion angle θ2 and the refractive index of the lens 20 corresponding to the long wavelength. A middle/long transmitted light L22 is imaged on a middle/long image formation point F22 of the middle/long image formation distance f22 at a middle/long conversion angle θ22, which is different from the far/long conversion angle θ12.

As shown in FIG. 3(b), the refractive index of the middle/short transmitted light L21 (such as the middle/short conversion angle θ21) corresponding to the short wavelength 400 nm of the lens 20, of which chromatic aberrations is not corrected, is larger than the refractive index of the middle/long transmitted light L22 (such as the middle/long conversion angle θ22) corresponding to the long wavelength 800 nm. Therefore, the middle/short image formation distance f21 is shorter than the middle/long image formation distance f22. Therefore, difference D2 in middle image formation distances (D2=middle/long image formation distance f22−middle/short image formation distance f21) is generated between the middle/short transmitted light L21 and the middle/long transmitted light L22 as the image formation relative quantity generated by the difference in wavelengths.

The measurement target T shown in FIG. 3(c) is positioned away from the lens 20 by a near/target distance s3, which is shorter than the middle target distance s2. A near expansion angle θ3 shown in FIG. 3(c) is larger than the middle expansion angle θ2 in FIG. 3(b). When the near/incident light L3 is a single wavelength light having a short wavelength of 400 nm, the refraction degree of the near/incident light L3 is determined based on the near/expansion angle θ3 and the refractive index of the lens 20 corresponding to the short wavelength. For example, in this case, a near/short conversion angle θ31 is different from the middle/short conversion angle θ21, and a near/short image formation point F31 of the near/short image formation distance f31, which allows the near/short transmitted light L31 to be imaged, is also different from the case of FIG. 3(b).

In contrast, when the near/incident light L3 is a single wavelength light having a long wavelength of 800 nm, the near/incident light L3 is refracted based on the near/expansion angle θ3 and the refractive index of the lens 20 corresponding to the long wavelength. A near/long transmitted light L32 is imaged on a near/long image formation point F32 of the near/long image formation distance f32 at a near/long conversion angle θ32 which is different from the middle/long conversion angle θ22.

As shown in FIG. 3(c), the refractive index (a near/short conversion angle θ31) of the near/short transmitted light L31 corresponding to the short wavelength 400 nm of the lens 20 of which chromatic aberrations are not corrected is larger than the refractive index (a near/long conversion angle θ32) of the near/long transmitted light L32 corresponding to the long wavelength 800 nm. Therefore, the near/short image formation distance f31 is shorter than the near/long image formation distance f32. Accordingly, difference D3 in near/image formation distances (D3=near/long image formation distance f32−near/short image formation distance f31) is generated between the near/short transmitted light L31 and the near/long transmitted light L32 as the image formation relative quantity generated by the difference in wavelengths.

Further, even in a case of lights having the same wavelength, the image formation distance f of the transmitted light transmitted through the lens 20 is different from each other in accordance with a difference in angles of the light incident on the lens 20. This is because the expansion angle θ of the incident light L becomes larger as the target distance s or the measurement distance as the distance from the lens 20 to the measurement target T becomes shorter. Conversely, as the target distance s becomes longer, the expansion angle θ of the incident light L becomes small. This is because generally, as the expansion angle θ of the incident light L becomes larger, the conversion angle of the transmitted light transmitted from the lens 20 becomes larger. That is, as the target distance s, which is the distance between the lens 20 and the measurement target T becomes shorter, the expansion angle θ of the incident light L becomes larger, and the conversion angle becomes larger. As a result, the image formation distance f becomes shorter. Conversely, as the target distance s becomes longer, the expansion angle θ of the incident light L becomes smaller, and the conversion angle becomes smaller. As a result, the image formation distance f becomes longer.

Therefore, explanation will be given for a variation of the image formation distance f in a case in which the target distance s, which is the distance between the lens 20 and the measurement target T, is different from each other. First, explanation will be given for the correlation between the target distance s and the image formation distance f (focal distance f) in a case in which the light is a short wavelength light. The image formation distance of the image of the measurement target T is the far/short image formation distance f11 in a case in which a far target distance is s1 as shown in FIG. 3(a), and is the middle/short image formation distance f21 in a case in which the middle target distance is s2 as shown in FIG. 3(b). The middle target distance s2 of the middle incident light L2 shown in FIG. 3(b) is shorter than the far target distance s1 of the far incident light L1 shown in FIG. 3(a), and therefore the middle expansion angle θ2 of the middle incident light L2 is larger than the far expansion angle θ1 of the far incident light L1. Therefore, the middle/short conversion angle θ21 of the middle incident light L2 is larger than the far/short conversion angle θ11 of the far incident light L1. Accordingly, since the middle/short image formation distance f21 is shorter than the far/short image formation distance f11, far/middle/short difference D11 (D11=f11−f21) is generated between the far/short image formation distance f11 and the middle/short image formation distance f21 as the difference between image formation distances.

Next, explanation will be given for the correlation between the target distance s and the image formation distance f (focal distance) in a case in which the light is a long wavelength light. As can be seen from FIGS. 3(a) and 3(b), the middle/long image formation distance f22 is shorter than the far/long image formation distance f12. Therefore, far/middle/long difference D12 (D12=f12−f22) is generated between the far/long image formation distance f12 and the middle/long image formation distance f22.

The refractive index of the lens 20 is different for each wavelength. Therefore, the correlation (or ratio) between the far/short conversion angle θ11 and the middle/short conversion angle θ21 generated by the refractive index of the lens 20 of the short wavelength is different from the correlation (or ratio) between the far/long conversion angle θ12 and the middle/long conversion angle θ22 formed by the refractive index of the lens 20 of the long wavelength. That is, these correlations are not matched with each other. Also, the far/middle/short difference D11, which is the difference between image formation distances generated by change of the far/short conversion angle θ11 to the middle/short conversion angle θ21 in a case of a short wavelength, is different from the far/middle/long difference D12, which is the difference between image formation distances generated by change of the far/long conversion angle θ12 to the middle/long conversion angle θ22 in a case of a long wavelength, and usually they are not matched with each other.

This indicates that the correlation between the difference D1 and the difference D2 are expressed by the relational expression described below, wherein the difference D1 is the difference between far image formation distances in a case in which the target distance to the measurement target T is a far target distance s1, and the difference D2 is the difference between middle image formation distances in a case in which the target distance to the measurement target T is the middle target distance s2. Difference D2 in middle image formation distances=difference D1 in far image formation distances+far/middle/short difference D11−far/middle/long difference D12. This relational expression can be confirmed by adjusting D1, D2, D11, and D12 to delete f11, f12, f21, and f22 from this relational expression.

Further, it is also confirmed that the difference D1 in far image formation distances and the difference D2 in middle image formation distances are usually different values from each other. That is, the difference D1 in far image formation distances when the target distance to the measurement target T is the far target distance s1 is different from the difference D2 in middle image formation distances when the target distance to the measurement target T is the middle target distance s2. Therefore, it can be concluded that the difference D1 in far image formation distances corresponds to the far target distance s1, and the difference D2 in middle image formation distances corresponds to the middle target distance s2. Then, it is found that the distance can be measured using this relationship.

Similarly, explanation will be given for a case in which the target distance to the measurement target T is the near target distance s3. When the optical wavelength is a short wavelength, the near/short transmitted light L31 having the near/short conversion angle θ31 which is larger than the far/short conversion angle θ11 and the middle/short conversion angle θ21 is imaged on the near/short image formation point F31 of the near/short image formation distance f31. That is, far/near/short difference D21 is generated between the near/short image formation distance f31 and the far/short image formation distance f11 due to the fact that the near/short image formation distance f31 is shorter than the far/short image formation distance f11. Similarly, when the optical wavelength is a long wavelength, the near/long transmitted light L32 having the near/long conversion angle θ32 which is larger than the far/long conversion angle θ12 and the middle/long conversion angle θ22 is imaged on the near/long image formation point F32 of the near/long image formation distance f32. That is, far/near/long difference D22 is generated between the near/long image formation distance f32 and the far/long image formation distance f12 due to the fact that the near/long image formation distance f32 is shorter than the far/long image formation distance f12.

At this time as well, since the lens 20 has different refractive indexes for each wavelength, the correlation (or the ratio) between the far/short conversion angle θ11 and the near/short conversion angle θ31, based on the refractive index corresponding to the short wavelength, is normally different from the correlation (or the ratio) between the far/long conversion angle θ12 and the near/long conversion angle θ32, based on the refractive index corresponding to the long wavelength, and they are not matched with each other. Further, a far/near/short difference D21 generated in the image formation distance by change of the far/short conversion angle θ11 to the near/short conversion angle θ31 in a case of a short wavelength is also different from the far/near/long difference D22 generated in the image formation distance by change of the far/long conversion angle θ12 to the near/long conversion angle θ32 in a case of a long wavelength, and they are not matched with each other. This indicates that the correlation between the difference D1 in far image formation distances and the difference D3 in near image formation distances is expressed by a relational expression as follows: Difference D3 in near image formation distances=difference D1 in far image formation distances+[far/near/short difference D21−far/near/long difference D22], wherein D1 is the difference between far image formation distances when the far target distance to the measurement target T is s1, and D3 is the difference between near image formation distances when the near target distance to the measurement target T is s3, and the difference D1 in far image formation distances and the difference D3 in near image formation distances are normally different values from each other.

Although the explanation is omitted for the illustrative purposes, similarly to the relationship between the difference D1 in far image formation distances and the difference D3 in near image formation distances, the difference D2 in middle image formation distances and the difference D3 in near image formation distances are usually different values from each other. That is, the difference D1 in far image formation distances when the target distance to the measurement target T is the far target distance s1, the difference D2 in middle image formation distances when the target distance to measurement target T is the middle target distance s2, and the difference D3 in near image formation distances when the target distance to measurement target T is the near target distance s3 are different from each other. Therefore, the difference between the near image formation distance D3 can be calculated in association with the near target distance s3.

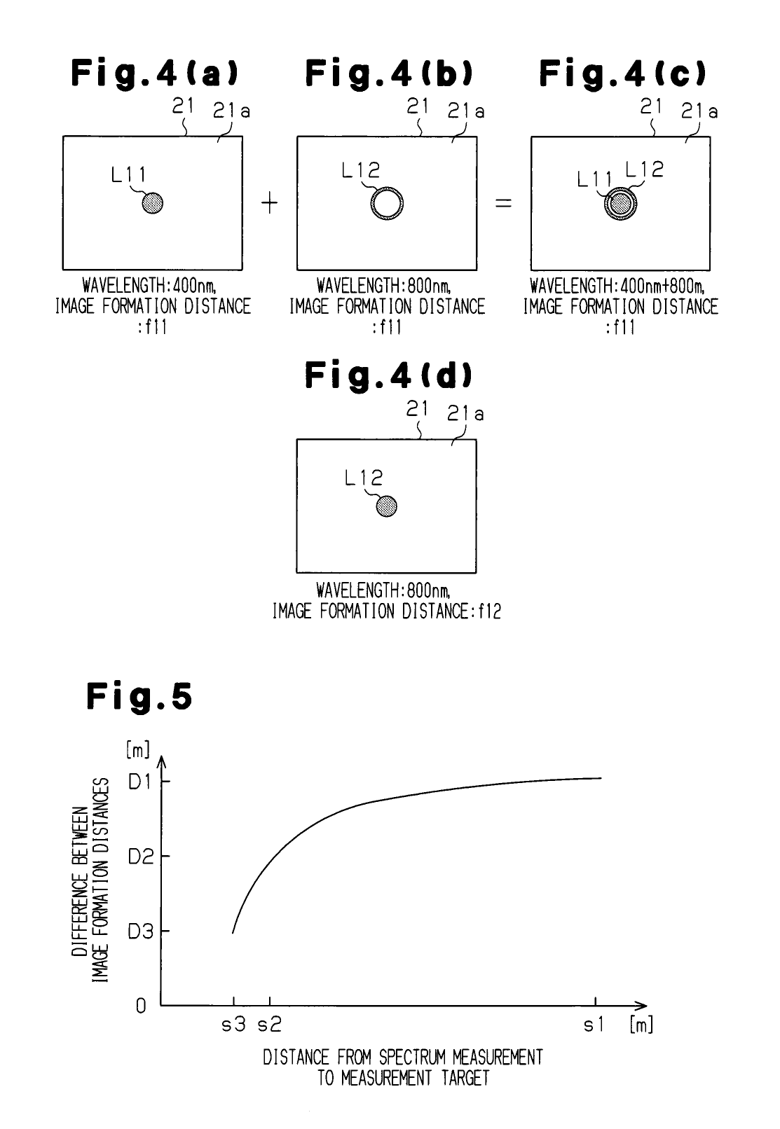

As shown in FIG. 4(a), the far/short transmitted light L11 having a short wavelength of 400 nm forms an image of the measurement target T on the image formation plane 21a positioned in the far/short image formation distance f11. In contrast, as shown in FIG. 4(b), when the far/long transmitted light L12 with the wavelength of 800 nm having the far/long image formation distance f12 which is longer than the far/short image formation distance f11 is projected on the image formation plane 21a positioned in the far/short image formation distance f11, for example, an image of the measurement target T, which is blurred annularly, is shown. That is, the image of the measurement target T formed by the far/long transmitted light L12 is not imaged on the image formation plane 21a positioned in the far/short image formation distance f11.

FIG. 4(c) shows an image obtained by combining the image formed by the short wavelength light and an annularly blurred image formed by the long wavelength light, by simultaneously projecting the aforementioned short wavelength image and the long wavelength image which are the same measurement targets T, on the image formation plane 21a positioned in the far/short image formation distance f11. As shown in FIG. 4(d), the image formation plane 21a positioned in the far/long image formation distance f12 shows the image of the measurement target T which is formed by the long wavelength light and also which is formed by the far/long transmitted light L12. Thus, it is found that an image formation position of the light each having a wavelength projected on the image formation plane 21a can be detected by moving the image formation plane 21a.

Thus, the spectral sensor 14 detects a spectral image formed by the short wavelength light, and the spectral data R0 including the spectral image formed by the long wavelength light, the spectral images being obtained by imaging the measurement target T. When the spectral image is detected, the spectral sensor 14 outputs the spectral data R0 and image formation distance data F0 to a spectral data processor 15.

The spectral data processor 15 is mainly constituted of a microcomputer having an arithmetic unit and a storage unit, and the like. The spectral data processor 15 is connected to the spectral sensor 14, and therefore the spectral data R0 of observation light and the image formation distance data F0 are input from the spectral sensor 14. The spectral data processor 15 calculates (measures) the distance to the measurement target T based on the input spectral data R0 and the image formation distance data F0.

As shown in FIG. 1, the spectral data processor 15 includes an arithmetic unit 16 and a storage unit 17 as storage means. The storage unit 17 includes the whole portion or one portion of a storage area in a known storage device.

FIG. 5 shows map data 18 stored in a storage area of a storage unit 17. The map data 18 is the data in association with the target distance s, and shows the difference between the image formation distance of the short wavelength light and the image formation distance of the long wavelength light. The map data 18 stores the difference D1 in far image formation distances and the difference D2 in middle image formation distances. The difference D1 in far image formation distances is the difference between the short wavelength far/short image formation distance f11 and the long wavelength far/long image formation distance f12 corresponding to the far target distance s1 to the measurement target T, and the difference D2 in middle image formation distances is the difference between the short wavelength middle/short image formation distance f21 and the long wavelength middle/long image formation distance f22 corresponding to the middle target distance s2 to the measurement target T. Further, the map data 18 stores the difference D3 in near image formation distances, which is the difference between the short wavelength near/short image formation distance f31 and the long wavelength near/long image formation distance f32 corresponding to the near target distance s3 to the measurement target T. Therefore, the arithmetic unit 16 can capture from the map data 18, for example, the far target distance s1, the middle target distance s2, and the near target distance s3, when the difference between far image formation distances is D1, when the difference between middle image formation distances is D2, and when the difference between near image formation distances is D3, respectively. That is, the map data 18 indicates correlation information as the information, determined from a target distance s and the chromatic aberration characteristic of the lens 20 in order to show the correlation between the difference between image formation distances and the distance to the measurement target of the image of a light having two wavelengths.

As shown in FIG. 1, the arithmetic unit 16 includes a pixel-of-interest selection part 30 for selecting a pixel used for measuring the distance from the image of the measurement target T and an image formation distance detection part 31 for detecting the image formation distance of two wavelengths for each selected pixel. Further, the arithmetic unit 16 includes an image formation relative quantity calculation part 32 as a relative relationship quantity calculation part for calculating the difference between two image formation distances, and a distance calculation part 33 for calculating the target distance s based on the difference between image formation distances. Image formation relative quantity calculating means includes the image formation distance detection part 31 and the image formation relative quantity calculation part 32.

The pixel-of-interest selection part 30 selects a pixel used for measuring the distance from the image of the measurement target T. The pixel-of-interest selection part 30 has spectral data R0 and image formation distance data F0 input from the spectral sensor 14, and outputs the image formation distance data F0 and spectral data R1 including selected pixel information to the image formation distance detection part 31. The pixel may be selected from identified measurement targets, based on target identification processing performed separately, in such a way that the pixel corresponding to the measurement target with higher priority is selected, or the pixel corresponding to the one occupying a large area is selected.

The image formation distance detection part 31 detects each image formation distance of light having two wavelengths regarding the pixel selected by the pixel-of-interest selection part 30. The image formation distance detection part 31 has image formation distance data F0 and spectral data R1 input from the pixel-of-interest selection part 30, and outputs the image formation distance data R2 including the detected image formation distance of two wavelengths to the image formation relative quantity calculation part 32. Further, the image formation distance detection part 31 outputs to the drive unit 22 a driving command signal R10 for changing the image formation distance f of the detector 21. Further, the image formation distance detection part 31 can judge a blurring amount of the pixel selected based on the spectral data R1, that is, definition, by a known method. The definition of the image may be judged, for example, based on the degree of variation of the light quantities between the pixel by which an image of the measurement target T is formed and the pixel in the circumference of the image. For example, when the blurring amount of the image is small, namely when the image is sharp, there is a tendency that the degree of variation of pixels and light quantities in the circumference becomes large. In contrast, when the blurring amount of the image is large, namely when the definition of the image is poor, there is a tendency that the degree of variation of pixels and light quantities in the circumference becomes small. Further, the definition can also be judged by a frequency component of the image such as a boundary portion of the image. That is, when the frequency component on the boundary portion of the image is large, the image is sharp, namely the blurring amount is small, and therefore variation amount of the light quantities between pixels can be judged to be large. In contrast, when the frequency component is small, the definition of the image is poor, namely the blurring amount is large, and therefore the variation amount of the light quantities between pixels can be judged to be small. Thus, the image formation distance detection part 31 detects the short wavelength image formation distance (such as f11) and the long wavelength image formation distance (such as f12) of the image of the measurement target T by moving the detector 21 using the drive unit 22 while judging the definition of the image. The image formation distance detection part 31 inputs each of image formation distances of each detected wavelength (f11, f12, and the like) into the image formation relative quantity calculation part 32 as the image formation distance data R2 which is the data corresponding to each wavelength.

The image formation relative quantity calculation part 32 calculates the difference between image formation distances, which is the difference between image formation distances of two wavelengths. Based on the image formation distance data R2 input from the image formation distance detection part 31, the image formation relative quantity calculation part 32 calculates the difference between the image formation distances of two wavelengths (for example, far/short image formation distance f11 and far-long image formation distance f12). Further, the image formation relative quantity calculation part 32 outputs the calculated difference to the distance calculation part 33, as difference data R3, which is the data corresponding to two wavelengths.

The distance calculation part 33 is distance calculating means for calculating the target distance s based on the difference data R3. The distance calculation part 33 selects the map data 18 corresponding to two wavelengths from the storage unit 17 based on two wavelengths (for example, 400 nm and 800 nm) acquired from the difference data R3. Then, the distance calculation part 33 acquires, from the selected map data 18, the target distance s (for example, the far target distance s1) corresponding to the difference between image formation distances (for example, difference D1 in far image formation distances) acquired from the difference data R3. Then, the distance calculation part 33 associates the acquired target distance s with the measurement target T, for example, to thereby generate distance data R4, and outputs this distance data R4 to the human machine interface 12 and a vehicle controller 13, and the like.

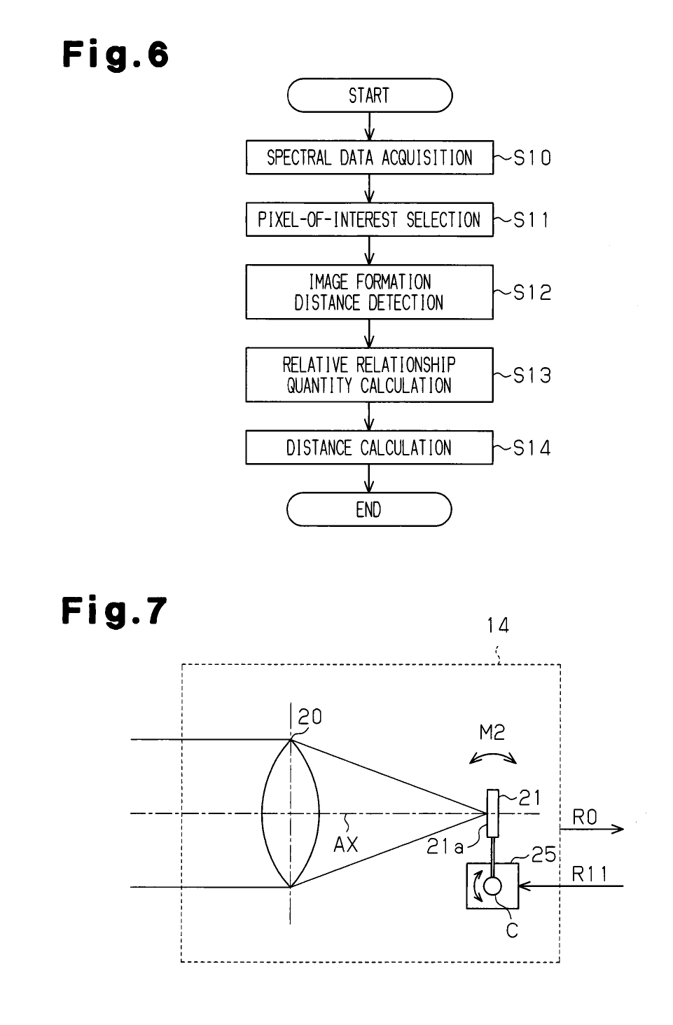

FIG. 6 shows a procedure of measuring the distance to the measurement target. That is, the flowchart of FIG. 6 shows the procedure of measuring the target distance s by the spectrum measurement device 11 of the embodiment. In this embodiment, the procedure of measuring the target distance is sequentially executed by a predetermined cycle.

As shown in FIG. 6, in step S10, when the processing for measuring the distance is started, the arithmetic unit 16 acquires the spectral data R0 which is acquired by the spectral sensor 14. When the spectral data R0 is acquired, in step S11, the arithmetic unit 16 selects the pixel including the image of the measurement target T as the pixel of interest. The measurement target T is selected based on the measurement target specially identified by the spectrum measurement device 11 and a priority of the measurement target as conditions. When the pixel of interest is selected, in step S12, the arithmetic unit 16 detects the image formation distances of the image of light having two wavelengths that have been selected for measuring the distance (image formation distance detecting step). The image formation distance f is obtained based on the definition of the image formed on the image formation plane 21a, which is changed by moving the detector 21. When the image formation distance f is detected, in step S13, the arithmetic unit 16 calculates the image formation relative quantity D as the relative relationship quantity between the image formation distances of the image of light having two wavelengths (relative relationship quantity calculating step). The image formation relative quantity D is calculated as the differences in image formation distances (D1, D2, D3) based on each image formation distance of the image of the light having two wavelengths. When the image formation relative quantity D is calculated, in step S14, the arithmetic unit 16 calculates the target distance s (distance calculating step). The target distance s is calculated by acquiring the distance corresponding to the image formation distance from the map data 18 related to the light having two wavelengths s wherein difference between image formation distances is calculated.

Thus, in this embodiment, the difference between image formation distances of two wavelengths is used. Therefore, for example, the difference between image formation distances can be adjusted so as to be suitably varied for measuring the distance, compared with a case in which the target distance s is obtained based on the image formation distance of a single wavelength. That is, by selecting two wavelengths, the difference between image formation distances can be varied greatly in accordance with the target distance s, so that measurement precision can be adjusted.

As described above, according to the spectrum measurement device of this embodiment, the following advantages are obtained.

(1) Normally, the lens 20 has different refractive indexes for each light having a wavelength. That is, when the image of light having multiple wavelengths is formed, the lens 20 generates chromatic aberrations, and therefore the image formation distances vary with each light having a wavelength. Further, the image formation distance of the image of single wavelength light is also varied by the difference of the expansion angle θ of the incident light L incident on the lens 20, due to the variation of the distance between the lens 20 and the measurement target T. The lens 20 is generally designed so that the image formation distance of light having multiple wavelengths may be matched with each other in a particular case in which the light has a wavelength desired to be obtained, such as the wavelength of red light, green light, and blue light, for images. In other words, chromatic aberrations are corrected.

As described above, the target distance s is calculated (measured) in the following manner. That is, the map data 18 as the correlation information, which is information determined by the target distance s and the chromatic aberration characteristic of the lens 20, is compared with the difference between image formation distance calculated by detection so that it is shown a correlation between the difference between image formation distances of the image of light having two wavelengths and the distance to the measurement target. Thus, even in a case where the lens 20 (optical system) of which difference between image formation distances (chromatic aberrations) is not corrected for each wavelength is used, the target distance s can be measured. That is, the distance measurement device is capable of simplifying the structure of the optical system such as the lens 20 because there is no necessity for correcting the difference between image formation distances (chromatic aberrations) for each wavelength.

(2) Further, according to this embodiment, the image formation distance of each wavelength is detected using the same lens 20 (optical system), to thereby obtain the difference between image formation distances (chromatic aberrations) for each wavelength. Thus, the distance can be measured by one optical system, namely by one camera (spectral sensor 14). Therefore, compared with a case in which a plurality of cameras are used, for example, the degree of freedom of arranging the camera, and the like can be increased, and there is no necessity for maintaining the arrangement position of the camera with high precision, thus making it possible to simplify the structure of the distance measurement device.

(3) Further, according to this embodiment, a light having a wavelength of which the image formation distance is not corrected is used for measuring the distance. Therefore, the degree of freedom of selecting and designing the wavelength used for the distance measurement device is increased, and the degree of selecting and designing the optical system used for this distance measurement device is also increased.

(4) The lens 20 measures the target distance s based on light having two wavelengths of different focal distances (image formation distances). That is, the distance to the measurement target T can be measured even in a case of a light having two wavelengths, and therefore execution of the distance measurement is easy.

(5) The difference between image formation distances (D1, D2, D3), namely the chromatic aberrations are detected, as the image formation relative quantities of light having two wavelengths. Therefore, the arithmetic operation required for the detection is easy.

(6) According to this embodiment, the image formation distance can be obtained directly from the distance between the lens 20 and the image formation plane 21a by varying the distance between the lens 20 and the image formation plane 21a. Therefore, the detection of the image formation distance is easy.

(7) When the image formation distance is obtained, the image formation plane 21a is moved with respect to the lens 20. Thus, the image formation plane 21a which is smaller than the optical system is moved, and therefore miniaturization and simplification of the device is achieved. The image formation plane 21a constituted of the picture elements such as a CCD is smaller and lighter than the optical system, and therefore a simple moving structure of the image formation plane 21a can be achieved.

(8) The spectral sensor 14 detects the image of light having multiple wavelengths of the measurement target T formed by the lens 20. Therefore, light having any multiple wavelengths can be detected. Thus, the degree of freedom of selecting the wavelength is increased, thus making it easy to suitably select the light having a wavelength suitable for measuring distance in accordance with the surrounding environment and the ambient light. Further, the spectral sensor 14 can originally detect light having multiple wavelengths, thus making it easy to construct the distance measurement device. That is, that makes it possible to construct the distance measurement device using the existing spectral sensor as well.

### Second Embodiment

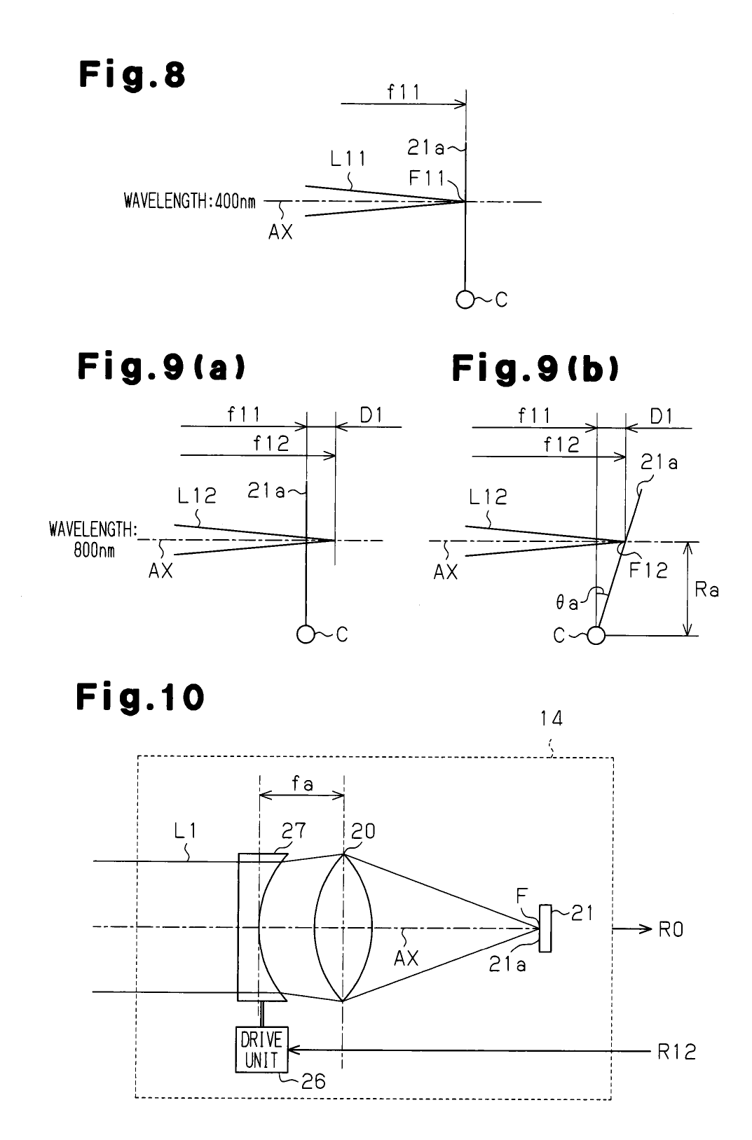

FIGS. 7 to 9 illustrate a spectrum measurement device according to a second embodiment, which shows the distance measurement device according to the present invention. FIG. 7 schematically shows the structure of a spectral sensor 14. FIG. 8 schematically shows a case in which the image of a light having a wavelength of 400 nm is formed. FIG. 9(a) shows a case in which the image of a light having a wavelength of 800 nm is not formed on the image formation plane 21a, and FIG. 9(b) shows a case in which the image is formed on the image formation plane 21a. In this embodiment, the structure of the spectral sensor 14 is that the image formation plane 21a is not linearly moved but rotatably moved, and this rotational movement is different from the structure of the first embodiment. The other structure other than the above is similar to the first embodiment, and therefore different points from the first embodiment will be mainly described, and same numbers are assigned to the same components and overlapping explanation is omitted.

As shown in FIG. 7, the distance measurement device has a swing shaft C for swinging the detector 21 and a swinging device 25 for driving the swing shaft C. The swing shaft C extends in a direction perpendicular to the optical axis AX of the lens 20. A support bar extending from the swing shaft C is connected to an end portion of the detector 21. The image formation distance detection part 31 turns the swing shaft C in a swing direction M2 shown by arrow by giving a rotation drive command signal R11 to the swinging device 25. Therefore, the image formation plane 21a is moved back and forth in an arch shape with respect to the lens 20. That is, the distance between the lens 20 and the image formation plane 21a is varied with the swing of the swing shaft C. That is, by swinging the swing shaft C, the image formation distances of the image of short wavelength light and the image of long wavelength light, which are incident on the lens 20, can be detected from the distance (image formation distance f) between the lens 20 and the image formation plane 21a.

As shown in FIG. 8, when the image formation plane 21a is perpendicular to the optical axis AX, the far/short transmitted light L11 having a short wavelength of 400 nm is imaged on the far/short image formation point F11 at the far/short image formation distance f11. In this case, as shown in FIG. 9(a), the far/long transmitted light L12 having a long wavelength of 800 nm is not imaged on the image formation plane 21a, which exists at the far-short image formation distance f11. Therefore, the image formation plane 21a is inclined backward to a position of the far/long image formation distance f12 on the optical axis AX by rotating the swing shaft C by an angle ea so that the image formation plane 21a is laid down backward. As a result, the far/long transmitted light L12 having a long wavelength of 800 nm is imaged on the portion of the image formation plane 21a positioned at the far/long image formation point F12 at the far/long image formation distance f12. Thus, the difference D1 in far image formation distances can be obtained from the far/short image formation distance f11 and the far/long image formation distance f12. The variation amount of the distance with respect to the far/short image formation distance f11 can be calculated as Ra×tan θa, from distance Ra between the swing shaft C and the optical axis AX, and the angle θa of the swing shaft C.

As described above, according to this embodiment, the same advantages as the advantages of the aforementioned (1) to (8) according to the above first embodiment can be obtained, or an equivalent advantage thereto can be obtained, and also the advantages as will be listed below can be obtained.

(9) The image formation plane 21a is moved in the front-rear direction with respect to the lens 20 by swinging the swing shaft C. Therefore, the structure of moving the image formation plane 21a with respect to the lens 20 can be simplified.

The aforementioned embodiments may be modified as follows.

Each of the aforementioned embodiments is not limited to utilizing a filter to incident light before being incident on the lens 20. A filter may be applied to light transmitted from the lens 20. Thus, the degree of freedom is increased for capturing light having a predetermined wavelength.

Each of the aforementioned embodiments is not limited to referring to the map data 18 for calculating the target distance s based on the difference between image formation distances. The distance to the measurement target may be calculated from the difference between image formation distances based on the arithmetic operation. Thus, reduction of the storage area is achieved.

As shown in FIG. 10, a second lens 27 may be provided between the first lens 20 and the measurement target T. The second lens 27 is moved by the drive unit 26 in the front-rear direction with respect to the lens 20. The first lens 20 is fixed. The second lens 27 is a concave lens, and a concave surface of the second lens 27 is faced toward the lens 20. The spectral data processor 15 adjusts inter-lens distance fa, which is the distance between the first lens 20 and the second lens 27 by adjusting the movement amount of the second lens 27 based on a drive command signal R12. The second lens 27 increases the expansion angle θ of the incident light L incident on the first lens 20. That is, an increase of the inter-lens distance fa corresponds to a reduction of the distance (image formation distance f) between the first lens 20 and the image formation plane 21a.

Thus, based on the inter-lens distance fa between the first lens 20 and the second lens 27, the spectral data processor 15 may calculate the image formation distance of the image of the light each having a wavelength. That is, the present invention is not limited to a structure in which the image formation distance corresponding to each wavelength is detected by varying the distance between the first lens 20 and the detector 21, and the image formation distance corresponding to each wavelength may be detected while maintaining a fixed distance between the first lens 20 and the image formation plane 21a. In this structure as well, the degree of freedom can be increased in designing the optical system that can be employed in the distance measurement device.

Each of the aforementioned embodiments shows a case in which the detector 21 is moved on the optical axis AX, for example. However, the present invention is not limited thereto, and the lens may also be moved while maintaining the optical axis. Thus, the degree of freedom can be increased in designing the optical system that can be employed in the distance measurement device.

Each of the aforementioned embodiments shows a case in which the detector 21 is disposed on the image formation points (F11, F12, F21, F22, F31, F32) of the lens 20. However, the present invention is not limited thereto, and it is acceptable to dispose a slit that can be moved in the front-rear direction with respect to the lens, at a position that is the image formation point of the incident light. According to this structure, the same structure as the structure of one aspect of a known spectral sensor can be achieved, which is the structure in which optical intensity information of a plurality of wavelength bands is obtained by dispersion, for example, by a prism the light that passes through the slit which is fixed to a predetermined position. In contrast, when the slit is moved, the light having a wavelength in which the optical aberrations are not corrected is passed through the slit selectively based on the difference between image formation distances of the light. Therefore, based on the definition of the image of the light having a wavelength that allows the light to pass through the slit, the target distance s can be measured by detecting the image formation distances and calculating the difference between image formation distances. Thus, the possibility of employing one aspect of the known spectral sensor is increased.

Each of the aforementioned embodiments shows a case in which the difference between focal distances (difference between image formation distances) of the image of light having two wavelengths is regarded as the image formation relative quantity, for example. However, the present invention is not limited thereto, and it is acceptable that the ratio between the focal distances (ratio between the image formation distances) of light having two wavelengths is regarded as the image formation relative quantity. Thus, the degree of freedom is increased in a calculating method of the image formation relative quantity of light having two wavelengths. Therefore, a suitable measurement result can be obtained.

Each of the aforementioned embodiments shows a case in which the target distance s is calculated based on one difference between image formation distances, for example. However, the present invention is not limited thereto, and it is acceptable to calculate the distance to the measurement target based on a plurality of differences in image formation distances. Based on the plurality of differences in image formation distances, the distance to the measurement target can be obtained with high precision. Particularly, if the spectral sensor is used, a multiple of differences in image formation distances can be calculated based on the image formation distance of the image of the light having a wavelength that allows detection. The distance can easily be measured based on the multiple of differences in image formation distances, and the precision of the measured distance can be increased.

Each of the aforementioned embodiments shows a case in which the lens 20 is one convex lens, for example. However, the present invention is not limited thereto, and it is also acceptable that the lens is constituted of a plurality of lenses or includes a lens other than the convex lens as long as the system is an optical system capable of imaging the incident light. Thus, the degree of freedom is increased in designing the lens, and also the degree of freedom is increased in employing such a distance measurement device.

Each of the aforementioned embodiments shows a case in which the chromatic aberrations of the lens 20 are not corrected, for example. However, the present invention is not limited thereto, and it is also acceptable that the chromatic aberrations are corrected in a wavelength not used for the distance measurement, and it is also acceptable that the chromatic aberration correction is implemented for the lens 20 in a wavelength used for the distance measurement as long as the degree of correction is small. Thus, the possibility of employing the lens 20 in the distance measurement device is increased.

Each of the aforementioned embodiments shows a case in which the short wavelength is 400 nm and the long wavelength is 800 nm in the two wavelengths capable of obtaining the difference between image formation distances (image formation relative quantity), for example. However, the present invention is not limited thereto, and it is acceptable that the two wavelengths for obtaining the image formation relative quantity of the image formation distances can be selected from a visible light and an invisible light as long as they are in a relationship of generating the chromatic aberrations of the lens. That is, either shorter wavelength or longer wavelength than 400 nm may be used as the short wavelength, and either shorter wavelength or longer wavelength than 800 nm may be used as the long wavelength. Thus, the degree of freedom of selecting the wavelength in the distance measurement device is increased, and the distance can be suitably measured by selecting a combination of suitable wavelengths for measuring the distance. The invisible light may also include ultraviolet ray (near ultraviolet ray), infrared ray (including far infrared ray, middle infrared ray, near infrared ray).

Each of the aforementioned embodiments shows a case in which when the target distance s is far, the difference between image formation distances becomes large. However, the present invention is not limited thereto, and the difference between image formation distances may be varied in accordance with the variation of the distance to the measurement target. That is, the difference between image formation distances is varied variously depending on a relationship between characteristics or the like of the lens and a plurality of selected frequencies. Therefore, the difference between image formation distances and the distance to the measurement target may be in a relationship that can be associated with each other as map data, and the difference between image formation distances may be varied variously with respect to the distance to the measurement target. Thus, the degree of freedom can be increased in selecting the optical system that can be employed in the distance measurement device.

### DESCRIPTION OF REFERENCE NUMERALS

10: Vehicle
11: Spectral measurement device
12: Human machine interface
13: Vehicle controller
14: Spectral sensor
15: Spectral data processor
16: Arithmetic unit
17: Storage part
18: Map data
20: Lens
21: Detector
21a: Image formation plane
22: Drive unit
25: Swinging device
26: Drive unit
27: Second lens
30: Pixel-of-interest selection part
31: Image formation distance detection part
32: Image formation relative quantity calculation part as correlation calculation part
33: Distance calculation part
C: Swing shaft
T: Measurement target
AX: Optical axis
F11, F12, F21, F22, F31, F32: Image formation point

1. A distance measurement device for measuring target distance, which is distance to a measurement target, by optically detecting the measurement target using a lens, the device comprising:
image formation relative quantity calculating part that creates an image of the measurement target by causing light having a plurality of wavelengths emitted from the measurement target to form an image via a lens, and determines the imaging distances from the lens to the image for each wavelength, thereby calculating an image formation relative quantity as a quantity indicating a relative relationship between the image formation distances;
storing part for storing correlation information as information that is determined by chromatic aberration characteristics of the lens so as to indicate a correlation between the image formation relative quantity and the target distance; and
distance calculating part for calculating the target distance by comparing the image formation relative quantity with the correlation information.

2. The distance measurement device according to claim 1, wherein the light has two wavelengths having different image formation distances, and the correlation information forms map data in which the image formation relative quantity is associated with the target distance.

3. The distance measurement device according to claim 2, wherein the image formation relative quantity is a difference between image formation distances, which is the difference between the imaging distances of the two wavelengths.

4. The distance measurement device according to claim 2, wherein the image formation relative quantity is an image formation distance ratio, which is the ratio between the image formation distances of the two wavelengths.

5. The distance measurement device according to claim 2, wherein in order to determine the image formation distance, the image formation relative quantity calculating part is configured such that the distance between the lens and an image formation plane for picking up the image is variable.

6. The distance measurement device according to claim 5, wherein the image formation relative quantity calculating part is configured to move the image formation plane with respect to the lens.

7. The distance measurement device according to claim 6, wherein
the image formation plane is configured to swing about a swing shaft, and
the image formation relative quantity calculating part varies the distance between the lens and the image formation plane by controlling the swing of the image formation plane.

8. The distance measurement device according to claim 2, further comprising:
a second lens positioned between the first lens and the measurement target,
wherein the image formation relative quantity calculating part determines the image formation distance based on the distance between the first lens and the second lens.

9. The distance measurement device according to claim 1, wherein the first lens is a part of a spectral sensor for detecting light from the measurement target.

10. A method for measuring target distance, which is distance to a measurement target, by optically detecting the measurement target using a lens, the method comprising:
an image formation distance detecting step for creating an image of the measurement target by causing light having a plurality of wavelengths emitted from the measurement target to form an image via the lens, and detecting image formation distances from the lens to the image for each of the wavelengths;
a relative relationship quantity calculating step for calculating an imaging relative quantity, which is a quantity indicating a relative relationship between the image formation distances; and
a distance calculating step for calculating the target distance by matching the image formation relative quantity with correlation information, which is information determined by chromatic aberration characteristics of the lens to indicate a correlation between the image formation relative quantity and the target distance.

11. The method for measuring distance according to claim 10, wherein
in the image formation distance detecting step, the image formation distance is detected for each of the two wavelengths, and
in the distance calculating step, the correlation information is obtained from map data, in which the image formation relative quantity is associated with the target distance.

12. The method for measuring distance according to claim 10, wherein in the image formation distance detecting step, the image formation distances are detected for each wavelength based on a definition of the image.
